(19) United States
(12) Patent Application Publication
(10) Pub. No.: US 2024/0028788 A1
(43) Pub. Date: Jan. 25, 2024

(54) METHOD AND SYSTEM FOR PERFORMING CLEARANCE ANALYSIS OF A PRODUCT ASSEMBLY IN A COMPUTER AIDED-DESIGN (CAD) ENVIRONMENT

(71) Applicant: Siemens Industry Software Inc., Plano, TX (US)

(72) Inventors: Raman Garimella, Tustin, CA (US); Vinayak Gorave, Pune (IN); Swapnil Phadnis, Pune, Maharashtra (IN); Monika Shingavi, Ahmednagar, Maharashtra (IN); Rajneet Sodhi, Pune, Maharashtra (IN); Matthew Stevenson, Bury St. Edmunds (GB); Sumit Taraphdar, Pune, Maharashtra (IN)

(21) Appl. No.: 18/023,833

(22) PCT Filed: Aug. 31, 2020
(86) PCT No.: PCT/US2020/048807

§ 371 Date: Feb. 28, 2023

(51) Int. Cl. G06F 30/20; G06F 30/12

(52) U.S. Cl. CPC G06F 30/20; G06F 30/12; G06F 2119/20

(57) ABSTRACT

A method and system for performing clearance analysis of a product assembly in a computer-aided design (CAD) environment is disclosed. A method includes receiving a request for evaluating clearance between components of a product assembly in a CAD environment from a user device. The request includes a unique identifier of the product assembly. The method includes obtaining product data associated with the product assembly from a PDM database based on the unique identifier of the product assembly, and iteratively decomposing a product space including the product assembly in the CAD environment into a plurality of variable-sized partitions based on the product data. The method also includes selecting one or more variable-sized partitions for evaluating clearance between the components in the product assembly from the plurality of the variable-sized partitions, and evaluating clearance between the components in the selected variable-sized partitions.

### FIELD OF TECHNOLOGY

The present disclosure relates to the field of computer-aided analysis, and more particularly to a method and system for performing clearance analysis of a product assembly in a CAD environment.

### BACKGROUND

Generally, during designing of a new product, clearance analysis is performed to provide that components in a product assembly do not interfere with each other. The product assembly may include a number of components ranging from a few tens or hundreds of components in small sized product assemblies to several hundreds of thousands of components in large sized product assemblies such as automobiles, ships, industrial plants, etc. Typically, the clearance analysis is performed during design of a product, when a substantial portion of a component and subassembly is changed, new components or sub-assemblies are added to the product assembly, and/or the components and subassemblies are to be validated against multiple variants of the product.

The clearance analysis of the product assembly requires substantially higher computational resources, including a processor and a memory. Further, the clearance analysis of the product assembly may take longer, ranging from several hours to days, especially in the case of large sized product assemblies. This may be due to an n 2 cost of evaluating interferences in the clearance analysis, where ‘n’ is a number of components in the product assembly. The higher cost of clearance analysis in terms of computational resources and time may lead to longer times in providing validity of the product, substantially longer design iteration times for the product, a substantially increased price for clearance analysis, and a delay in time to market for the product.

### SUMMARY

The scope of the present disclosure is defined solely by the appended claims and is not affected to any degree by the statements within this description. The present embodiments may obviate one or more of the drawbacks or limitations in the related art. A method and system for performing clearance analysis for a product assembly in a computer-aided design (CAD) environment is disclosed.

In one aspect, a method includes receiving a request for evaluating clearance between components of a product assembly in a CAD environment from a user device. The request includes a unique identifier of the product assembly. The method includes obtaining product data associated with the product assembly from a product data management (PDM) database based on the unique identifier of the product assembly. Further, the method includes iteratively decomposing a product space including the product assembly in the CAD environment into a plurality of variable-sized partitions based on the product data. The method includes selecting one or more variable-sized partitions for evaluating clearance between the components in the product assembly from the plurality of the variable-sized partitions, and evaluating clearance between the components in the selected variable-sized partitions.

In iteratively decomposing the product space including the product assembly in the CAD environment into the plurality of variable-sized partitions, the method may include generating a flat list of the components in the product assembly based on the product data. The flat list of the components includes information related to a unique identifier of each component, a location of each component in the product space, and a bounding box associated with each component. The method may include computing a bounding box for the product assembly in the product space based on the flat list of components in the product assembly, and iteratively decomposing the bounding box including the product assembly in the product space into the plurality of variable-sized partitions.

In one embodiment, in iteratively decomposing the bounding box including the product assembly in the product space into the plurality of variable-sized partitions, the method may include decomposing the bounding box into at least two equal sized bounding boxes along each cartesian coordinate axis, and determining a direction along which the two equal sized bounding boxes is to be sub-divided based on an maximum objective function value associated with the cartesian coordinate axes. The method may include dividing the two equal-sized bounding boxes along the determined direction into a number of variable-sized partitions.

The method may include determining whether the number of components in any of the variable-sized partitions is greater than the pre-defined number of components. If the number of components in any of the variable-sized partitions is greater than the pre-defined number of components, the method may include repeating the above mentioned acts of decomposing, determining, dividing, and determining until the number of components in each variable-sized partition is less than or equal to the pre-defined number of components. If the number of components in any of the variable-sized partitions is not greater than the pre-defined number of components, the method may include storing information associated with the variable-sized partitions in a partition database.

In another embodiment, in iteratively decomposing the bounding box including the product assembly in the product space into the plurality of variable-sized partitions, the method may include predicting clearance analysis cost for evaluating clearance of the product assembly in the bounding box. In one exemplary implementation, the clearance analysis cost for evaluating clearance of the product assembly in the bounding box is predicted using a trained machine learning model. The method may include determining whether the predicted clearance analysis cost is less than or equal to a threshold clearance analysis cost. If the predicted clearance analysis cost is not less than or equal to the threshold clearance analysis cost, the method may include decomposing the bounding box into at least two equal-sized bounding boxes along cartesian coordinate axes, and computing clearance analysis cost for evaluating clearance of the components of the product assembly in the two equal-sized bounding boxes along each of the cartesian coordinate axes. The method may include determining a direction along which the two equal-sized bounding boxes is to be sub-divided along one of the cartesian coordinate axes that has a least combined clearance analysis cost, and dividing each bounding box along the determined direction into two variable-sized partitions.

The method may include determining whether the least combined clearance analysis cost associated with the variable-sized partitions is less than the predicted clearance analysis cost. If the least combined clearance analysis cost associated with the variable-sized partitions is not less than the predicted clearance analysis cost, the method may include repeating the above-mentioned steps of determining, decomposing, computing, determining, dividing, and determining until the clearance analysis cost for the variable-sized partitions becomes less than the predicted clearance analysis cost. If the least combined clearance analysis cost associated with the variable-sized partitions is less than the predicted clearance analysis cost, the method may include storing information associated with the variable-sized partitions in the partition database.

In yet another embodiment, in iteratively decomposing the product space including the product assembly in the CAD environment into the plurality of variable-sized partitions, the method may include generating a flat list of the components in the product assembly based on the product data. The flat list of the components includes information related to a unique identifier of each component, a location of each component in the product space, and a bounding box associated with each component. The method may include predicting clearance analysis cost for evaluating clearance of each component in the product assembly, and identifying one or more components having a predicted clearance analysis cost that is greater than a predetermined threshold value.

The method may also include computing a bounding box around each of the components having a predicted clearance analysis cost that is greater than the predetermined threshold value based on the flat list of components. The bounding box associated with each component includes one or more components that are within the bounding box of the respective component. The method may include determining whether there are one or more components remaining in the flat list that have a predicted clearance analysis cost that is less than or equal to the pre-determined threshold value. The method may include storing information associated with the bounding boxes in the partition database if there are no components remaining in the flat list.

If there are one or more components remaining in the flat list, the method may include generating a bounding box for the remaining components in the flat list of components, and decomposing the bounding box into at least two equal-sized bounding boxes along each cartesian coordinate axis. Further, the method may include determining a direction along which the two equal sized bounding boxes is to be sub-divided based on a maximum objective function value associated with the cartesian coordinate axes, and dividing the two equal-sized bounding boxes along the determined direction into a number of variable-sized partitions. The method may also include determining whether the number of components in any of the variable-sized partitions is greater than the pre-defined number of components. If the number of components in any of the variable-sized partitions is greater than the pre-defined number of components, the method may include repeating the above mentioned acts of decomposing, determining, dividing, and determining until the number of components in each variable-sized partition is less than or equal to the pre-defined number of components. The method may include storing information associated with the variable-sized partitions in the partition database if the number of components in any of the variable-sized partitions is not greater than the pre-defined number of components.

The method may include selecting the one or more variable-sized partitions from the plurality of variable-sized partitions based on at least one of pre-defined number of components in the variable-sized partitions and threshold clearance analysis cost associated with the variable-sized partitions.

In evaluating the clearance between the components in the respective variable-sized partitions, the method may include distributing the selected variable-sized partitions among a plurality of clearance workers. Each of the selected variable-sized partitions includes one or more component pairs on which clearance analysis needs to be performed. The method may include performing a clearance analysis on the respective component pairs in the respective variable-sized partitions using the clearance workers, and generating results of the clearance analysis performed on the respective component pairs in the respective variable-sized partitions. The method may also include generating a consolidated clearance result set for the product assembly based on the results of the clearance analysis for the respective variable-sized partition from the clearance workers, and outputting the consolidated clearance results set for the product assembly on a graphical user interface.

In another aspect, a data processing system for performing clearance analysis of a product assembly in a computer-aided design (CAD) environment includes a processing unit and a memory unit communicatively coupled to the processing unit. The memory unit includes a clearance analysis module stored in the form of machine-readable instructions and executable by the processing unit. The clearance analysis module is configured to receive a request for evaluating clearance between components of a product assembly in a CAD environment from a user device. The request includes a unique identifier of the product assembly. The clearance analysis module is configured to obtain product data associated with the product assembly from a product data management (PDM) database based on the unique identifier of the product assembly. Further, the clearance analysis module is configured to iteratively decompose a product space including the product assembly in the CAD environment into a plurality of variable-sized partitions based on the product data. The clearance analysis module is configured to select one or more variable-sized partitions for evaluating clearance between the components in the product assembly from the plurality of the variable-sized partitions, and evaluate clearance between the components in the selected variable-sized partitions.

In iteratively decomposing the product space including the product assembly in the CAD environment into the plurality of variable-sized partitions, the clearance analysis module is configured to generate a flat list of the components in the product assembly based on the product data. The flat list of the components includes information related to a unique identifier of each component, a location of each component in the product space, and a bounding box associated with each component. The clearance analysis module is configured to compute a bounding box for the product assembly in the product space based on the flat list of components in the product assembly, and iteratively decompose the bounding box consisting the product assembly in the product space into the plurality of variable-sized partitions.

In one embodiment, in iteratively decomposing the bounding box including the product assembly in the product space into the plurality of variable-sized partitions, the clearance analysis module is configured to decompose the bounding box into at least two equal sized bounding boxes along each cartesian coordinate axis, and determine a direction along which the two equal sized bounding boxes is to be sub-divided based on a maximum objective function value associated with the cartesian coordinate axes. The clearance analysis module is configured to divide the two equal-sized bounding boxes along the determined direction into a number of variable-sized partitions. The clearance analysis module is configured to determine whether the number of components in any of the variable-sized partitions is greater than the pre-defined number of components. If the number of components in any of the variable-sized partitions is greater than the pre-defined number of components, the clearance analysis module is configured to repeat the above mentioned acts of decomposing, determining, dividing, and determining until the number of components in each variable-sized partition is less than or equal to the pre-defined number of components. If the number of components in any of the variable-sized partitions is not greater than the pre-defined number of components, the clearance analysis module is configured to store information associated with the variable-sized partitions in a partition database.

In another embodiment, in iteratively decomposing the bounding box including the product assembly in the product space into the plurality of variable-sized partitions, the clearance analysis module is configured to predict a clearance analysis cost for evaluating clearance of the product assembly in the bounding box. In one exemplary implementation, the clearance analysis cost for evaluating clearance of the product assembly in the bounding box is predicted using a trained machine learning model.

The clearance analysis module is configured to determine whether the predicted clearance analysis cost is less than or equal to a threshold clearance analysis cost. If the predicted clearance analysis cost is not less than or equal to the threshold clearance analysis cost, the clearance analysis module is configured to decompose the bounding box into at least two equal sized bounding boxes along cartesian coordinate axes, and compute a combined clearance analysis cost for evaluating clearance of the components of the product assembly in the two equal-sized bounding boxes along each of the cartesian coordinate axes. The clearance analysis module is configured to determine a direction along which the two equal-sized bounding boxes is to be sub-divided along one of the cartesian coordinate axes, which has a least combined clearance analysis cost, and divide each bounding box along the determined direction into two variable-sized partitions. The clearance analysis module is configured to determine whether the least combined clearance analysis cost associated with the variable-sized partitions is less than the predicted clearance analysis cost. If the least combined clearance analysis cost associated with the variable-sized partitions is not less than the predicted clearance analysis cost, the clearance analysis module is configured to repeat the above-mentioned acts of determining, decomposing, computing, determining, dividing, and determining until the least combined clearance analysis cost for the variable-sized partitions becomes less than the predicted clearance analysis cost. If the least combined clearance analysis cost associated with the variable-sized partitions is less than the predicted clearance analysis cost, the clearance analysis module is configured to store information associated with the variable-sized partitions in the partition database.

In yet another embodiment, in iteratively decomposing the product space consisting the product assembly in the CAD environment into the plurality of variable-sized partitions, the clearance analysis module may be configured to generate a flat list of the components in the product assembly based on the product data. The flat list of the components includes information related to a unique identifier of each component, a location of each component in the product space, and a bounding box associated with each component. The clearance analysis module may be configured to predict clearance analysis cost for evaluating clearance of each component in the product assembly, and identify one or more components having a predicted clearance analysis cost that is greater than a predetermined threshold value.

The clearance analysis module may also be configured to compute a bounding box around each of the components having a predicted clearance analysis cost that is greater than the predetermined threshold value based on the flat list of components. The bounding box associated with each component includes one or more components that are within the bounding box of the respective component. The clearance analysis module may be configured to determine whether there are one or more components remaining in the flat list that have a predicted clearance analysis cost that is less than or equal to the pre-determined threshold value. The clearance analysis module may be configured to store information associated with the bounding boxes in the partition database if there are no components remaining in the flat list components.

If there are one or more components remaining in the flat list, the clearance analysis module may be configured to generate a bounding box for the remaining components in the flat list of components, and decompose the bounding box into at least two equal sized bounding boxes along each cartesian coordinate axis. Further, the clearance analysis module may be configured to determine a direction along which the two equal sized bounding boxes is to be sub-divided based on a maximum objective function value associated with the cartesian coordinate axes, and divide the two equal-sized bounding boxes along the determined direction into a number of variable-sized partitions. The clearance analysis module may also be configured to determine whether the number of components in any of the variable-sized partitions is greater than the pre-defined number of components. If the number of components in any of the variable-sized partitions is greater than the pre-defined number of components, the clearance analysis module may be configured to repeat the above mentioned acts of decomposing, determining, dividing, and determining until the number of components in each variable-sized partition is less than or equal to the pre-defined number of components. The clearance analysis module may be configured to store information associated with the variable-sized partitions in the partition database if the number of components in any of the variable-sized partitions is not greater than the pre-defined number of components.

The clearance analysis module is configured to select the one or more variable-sized partitions from the plurality of variable-sized partitions based on at least one of pre-defined number of components in the variable-sized partitions and threshold clearance analysis cost associated with the variable-sized partitions.

In evaluating the clearance between the components in the respective variable-sized partitions, the clearance analysis module is configured to distribute the selected variable-sized partitions among a plurality of clearance workers. Each of the selected variable-sized partitions includes one or more component pairs on which clearance analysis needs to be performed. The clearance analysis module is configured to perform a clearance analysis on the respective component pairs in the respective variable-sized partitions using the clearance workers, and generate results of the clearance analysis performed on the respective component pairs in the respective variable-sized partitions. The clearance analysis module is also configured to generate a consolidated clearance result set for the product assembly based on the results of the clearance analysis for the respective variable-sized partition from the clearance workers, and output the consolidated clearance results set for the product assembly on a graphical user interface.

This summary is provided to introduce a selection of concepts in a simplified form that are further described below in the following description. It is not intended to identify features or essential features of the claimed subject matter. Further, the claimed subject matter is not limited to implementations that solve any or all disadvantages noted in any part of this disclosure.

### BRIEF DESCRIPTION OF THE DRAWINGS

FIG. 1 is a schematic representation of a data processing system for performing clearance analysis on a product assembly in a computer-aided design (CAD) environment, according to one embodiment.

FIG. 2 illustrates a detailed view of a clearance analysis module, as shown in FIG. 1, according to one embodiment.

FIG. 3 is a process flowchart of an exemplary method of performing clearance analysis on a product assembly in a CAD environment, according to one embodiment.

FIG. 4 is a process flowchart of an exemplary method of iteratively decomposing a product space including a product assembly in a CAD environment into a plurality of variable-sized partitions, according to one embodiment.

FIG. 5 is a process flowchart of an exemplary method of iteratively decomposing a product space including a product assembly in a CAD environment into a plurality of variable-sized partitions, according to another embodiment.

FIG. 6 is a process flowchart of an exemplary method of iteratively decomposing a product space including a product assembly in a CAD environment into a plurality of variable-sized partitions, according to yet another embodiment.

FIG. 7 is a schematic representation depicting a cloud computing system as shown in FIG. 1, according to one embodiment.

FIG. 8 illustrates a block diagram of a data processing system for performing clearance analysis on a product assembly in a CAD environment, according to another embodiment.

FIG. 9A is a schematic representation depicting a product space including a product assembly partitioned into a plurality of variable-sized partitions using a partitioning strategy, according to one embodiment.

FIG. 9B is a schematic representation depicting partitioning of the product space into the variable-sized partitions and number of components in each variable-sized partition, according to one embodiment.

### DETAILED DESCRIPTION

A method and system for performing clearance analysis on a product assembly in a computer-aided design (CAD) environment is disclosed. Various embodiments are described with reference to the drawings, where like reference numerals are used in reference to the drawings. Like reference numerals are used to refer to like elements throughout. In the following description, numerous specific details are set forth in order to provide a thorough understanding of embodiments. These specific details need not be employed to practice embodiments. In other instances, well known materials or methods have not been described in detail in order to avoid unnecessarily obscuring embodiments. While the disclosure is susceptible to various modifications and alternative forms, specific embodiments thereof are shown by way of example in the drawings and will herein be described in detail. There is no intent to limit the disclosure to the particular forms disclosed. Instead, the disclosure is to cover all modifications, equivalents, and alternatives falling within the spirit and scope of the present disclosure.

The terms ‘bounding box’ and ‘partition’ are interchangeably used throughout the document. Also, the terms ‘evaluation of clearance’ and ‘clearance analysis’ are interchangeably used throughout the document.

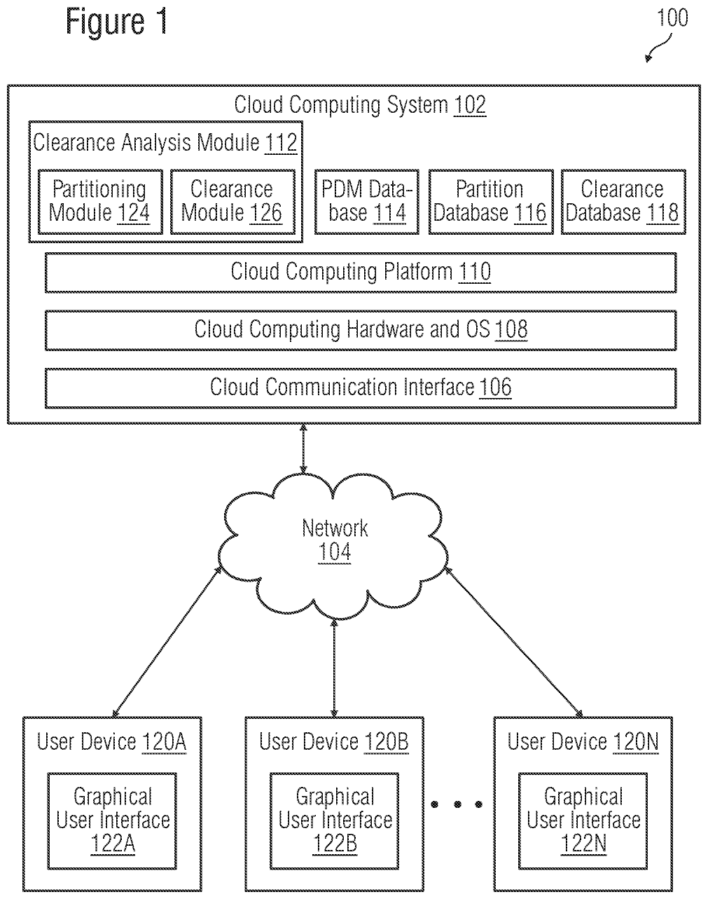

FIG. 1 is a schematic representation of a data processing system 100 for performing clearance analysis on a product assembly in a computer-aided design (CAD) environment, according to one embodiment. For example, the data processing system 100 includes a cloud computing system 102 configured for providing cloud services for clearance analysis of the product assembly associated with a product to be manufactured. The cloud computing system 102 may be part of public cloud infrastructure, private cloud computing infrastructure (also known as on-premise cloud), or hybrid cloud computing infrastructure (e.g., a combination of public and private cloud computing infrastructure).

The cloud computing system 102 includes a cloud communication interface 106, cloud computing hardware and OS 108, a cloud computing platform 110, a clearance analysis module 112, a PDM database 114, a partition database 116, and a clearance database 118. The cloud communication interface 106 enables communication between the cloud computing platform 110 and user devices 120A-N such as a smart phone, a tablet computer, a desktop computer, etc. via a network 104.

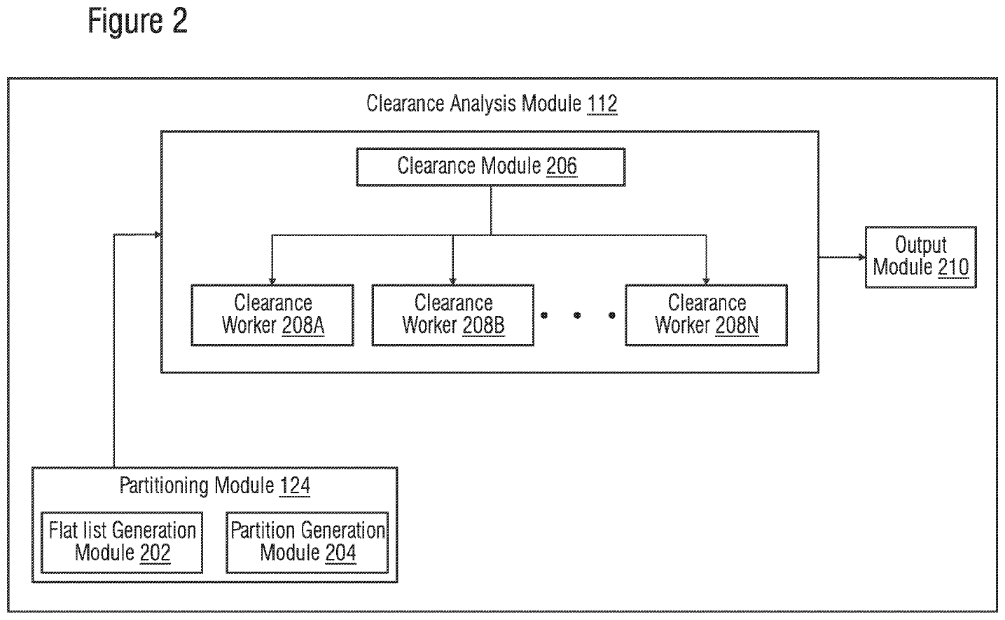

The cloud computing hardware and OS 108 may include one or more servers on which an operating system (OS) is installed and includes one or more processing units, one or more memory units for storing machine-readable instructions, one or more storage devices for storing data, and other peripherals required for providing cloud computing functionality. The cloud computing hardware and OS 108 is also known as cloud computing infrastructure. The cloud computing platform 110 is a platform that implements functionalities such as data storage, data analysis, data visualization, and data communication on the cloud hardware and OS 108 via APIs and algorithm; and delivers clearance analysis as a cloud service using cloud based application (e.g., clearance application). The cloud computing platform 110 employs the clearance analysis module 112 for performing clearance analysis on a product assembly and providing consolidated clearance results as described in greater detail with reference to FIGS. 2 to 6. The product assembly may include a number of sub-assemblies, and each sub-assembly may include a plurality of components. Each component may include a single part or several parts. For example, the product assembly may be a car assembly, a ship assembly, an aircraft assembly, and the like. In an example of the car assembly, a component may be a right front wheel or a left front wheel.

The clearance analysis module 112 includes a partitioning module 124 and a clearance module 126. The partitioning module 124 is configured to decompose a product space corresponding to the product assembly into variable-sized partitions based on a partitioning strategy (e.g., optimal number of components in a partition and/or optimal clearance analysis cost). The variable-sized partitions include a variable number of components from the product assembly. The clearance module 126 is configured for performing clearance analysis on each variable-sized partition in parallel and outputting consolidated clearance results for the product assembly. The clearance analysis is performed to check for clearances between the component pairs in the product assembly. Typically, the clearance analysis is performed during design of a product, when a substantial portion of a component and sub-assembly is changed, when new components or sub-assemblies are added to the product assembly, and/or when the components and sub-assemblies are to be validated against multiple variants of the product. For example, the clearance analysis module 126 may indicate the components in each partition and/or the entire product assembly that interfere with each other or have desired clearance. The data processing system 100 enables users (e.g., designers, manufacturers, and the like) to remotely perform clearance analysis on a product assembly in a time efficient manner.

The cloud computing platform 110 also includes the PDM database 114 for storing product data associated with product assemblies (e.g., fully configured three-dimensional CAD models of products), a partition database 116 for storing information associated with variable-sized partitions corresponding to one or more product assemblies on which clearance analysis is performed, and a clearance database 118 for storing clearance results associated with the one or more product assemblies on which the clearance analysis is performed.

The user devices 120A-N include graphical user interfaces 122A-N for receiving a request for performing clearance analysis on a product assembly and outputting consolidated clearance results associated with the product assembly. Each of the user devices 120A-N may be provided with a communication interface for interfacing with the cloud computing system 102. Users of the user devices 120A-N may access the cloud computing system 102 via the graphical user interfaces 122A-N. For example, the users may send a request to the cloud computing system 102 to perform clearance analysis on a product assembly. The graphical user interfaces 122A-N may be specifically configured for accessing the clearance analysis module 112 in the cloud computing system 102.

FIG. 2 illustrates a detailed view of a clearance analysis module 112 as shown in FIG. 1, according to one embodiment. As shown in FIG. 2, the clearance analysis module 112 includes the partitioning module 124, the clearance module 126, and an output module 210. The partitioning module 124 includes a flat list generation module 202 and a partition generation module 204. The flat list generation module 202 is configured for obtaining product data associated with a product assembly on which clearance analysis is to be performed from the PDM database 114 based on a unique identifier associated with the product assembly. The flat list generation module 202 is configured for generating a flat list of components in the product assembly based on the product data. For example, the flat list generation module 202 processes product structure of the product assembly and generates a flat list of absolute positioned occurrences. The flat list of occurrences includes information related to a unique identifier of each component, a location of each component in the product space, a reference to a CAD model containing geometry or facet information, and a bounding box associated with each component. The unique identifier may help in associating clearance results with the components in the product assembly. The flat list of occurrences is stored in a PDM independent occurrence data format.

The partition generation module 204 is configured for generating variable-sized partitions by iteratively decomposing the product space including the product assembly in the CAD environment based on the flat list of components. Each variable-sized partition is a volumetric decomposition of the product space. The variable-sized partitions include a variable number of absolutely positioned components of the product assembly. In one embodiment, the partition generation module 204 is configured for generating variable-sized partitions through recursive binary division of the product space such that each binary division takes place along one of three axially aligned directions (e.g., X, Y or Z) and results in multiple partitions that contain an approximately equal number of components.

In another embodiment, the partition generation module 204 is configured for generating variable-sized partitions through recursive binary division of the product space based on predicted clearance analysis cost. In this embodiment, the partition generation module 204 is configured for generating variable-sized partitions though recursive binary division of the product space along one of three axially aligned directions (e.g., X, Y, or Z) having approximately equal predicted clearance analysis cost. The binary division is performed until the clearance analysis cost of each final partition is close to a threshold clearance analysis cost or until the combined predicted clearance analysis cost of the sub-partitions along each of the three axially aligned directions is greater than clearance analysis cost of the partition being divided.

In yet another embodiment, the partition generation module 204 is configured for predicting clearance analysis cost for each component in the product assembly. The partition generation module 204 is configured for generating a first set of components having a predicted clearance analysis cost that is higher than a threshold value, and a second set of components having a predicted clearance analysis cost that is less than or equal to the threshold value. The partition generation module 204 is configured for generating a first set of variable-sized partitions containing each component in the first set of components and other components from the flat list that are within the bounding box of the respective component. The partition generation module 204 is configured for generating a second set of variable-sized partitions through recursive binary division of a product space corresponding to the second set of components based on equal approximate number of components approach. The partition generation module 204 is configured to generate a final set of variable-sized partitions including the first set of variable-sized partitions and the second set of variable-sized partitions.

The partition generation module 206 is configured for selecting one or more variable-sized partitions for evaluating clearance between the components in the product assembly from the plurality of the variable-sized partitions. The variable-sized partitions are selected such that the selected variable-sized partitions include components of the entire product assembly. Further, each of the selected variable-sized partitions includes one or more component pairs on which clearance analysis is to be performed.

The clearance module 126 includes a clearance scheduler 206 and clearance workers 208A-N. The clearance scheduler 206 is configured for distributing the selected variable-sized partitions among the clearance workers 208A-N. The clearance scheduler 206 provides that an appropriate number of clearance workers 208A-N are deployed for clearance analysis such that the variable-sized partitions are distributed over the clearance workers 208A-N, thereby minimizing time for clearance analysis and providing optimal utilization of the clearance workers 208A-N and priority of the clearance analysis.

The clearance workers 208A-N are configured for building a flat transient assembly structure for the components in the assigned variable-sized partitions. The clearance workers 208A-N are configured for performing clearance analysis on each component pair in the assigned variable-sized partitions using the flat transient assembly structure. In some embodiments, the clearance workers 208A-N are configured to eliminate redundant clearance analysis for pairs of components that are part of more than one variable-sized partitions. Methods used by the clearance workers 208A-N for performing clearance analysis on component pairs is well-known in the art and is therefore omitted. The clearance workers 208A-N are configured for generating results of the clearance analysis performed on the respective component pair in the assigned variable-sized partitions. In some embodiments, the clearance workers 208A-N run on container clusters hosted on container orchestration platforms such as Docker Swarm, Kubernetes, and the like. The output module 210 is configured for generating a consolidated clearance result set for the product assembly based on the results of the clearance analysis for the respective variable-sized partition from the clearance workers 208A-N. In some embodiments, the output module 210 filters out duplicate results of clearance analysis during generation of the consolidated clearance results set.

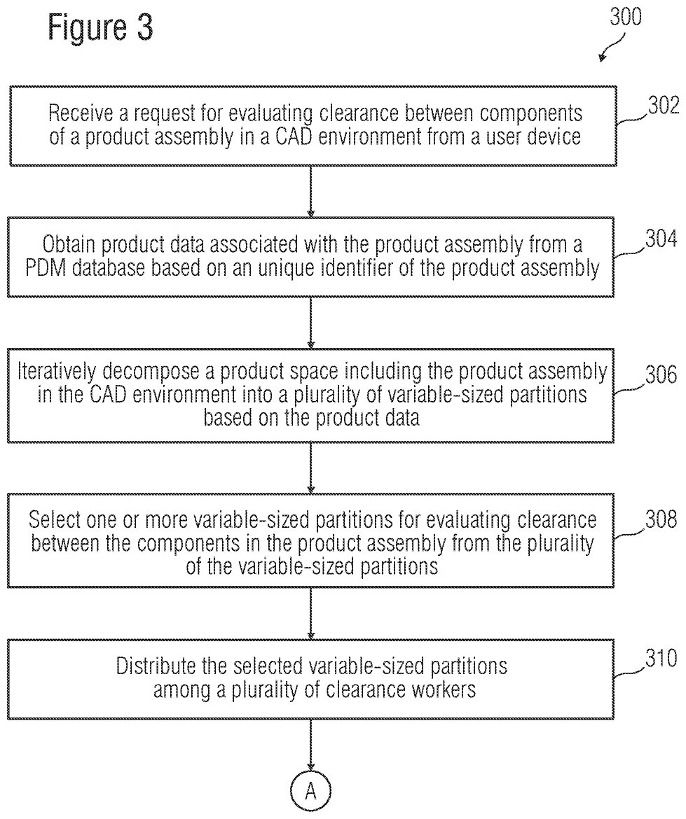

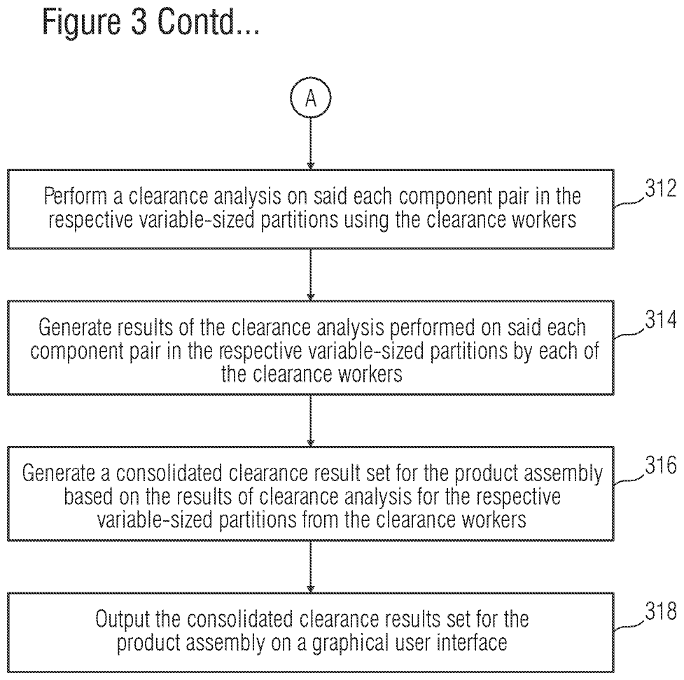

FIG. 3 is a process flowchart 300 of an exemplary method of performing clearance analysis on a product assembly in a CAD environment, according to one embodiment. At act 302, a request for evaluating clearance between components of a product assembly in a CAD environment is received from a user device 120A. The request includes a unique identifier of the product assembly. Additionally, the request may include clearance parameters such as type of clearance (e.g., exact geometric faces, faceted approximations, etc.), type of clearance result (e.g., interfering occurrences, body occurrences, etc.), priority of clearance analysis, and so on. At act 304, product data associated with the product assembly is obtained from a product data management (PDM) database based on the unique identifier of the product assembly.

At act 306, a product space including the product assembly in the CAD environment is iteratively decomposed into a plurality of variable-sized partitions based on the product data. The variable-sized partitions include a variable number of absolutely positioned components of the product assembly. At act 308, one or more variable-sized partitions for evaluating clearance between the components in the product assembly are selected from the plurality of the variable-sized partitions.

At act 310, the selected variable-sized partitions are distributed among a plurality of clearance workers. Each of the selected variable-sized partitions includes one or more component pairs on which clearance analysis needs to be performed. At act 312, a clearance analysis is performed on the respective component pair in the respective variable-sized partitions using the clearance workers. At act 314, results of the clearance analysis performed on the respective component pair in the respective variable-sized partitions are generated by each of the clearance workers. At act 316, a consolidated clearance result set for the product assembly is generated based on the results of the clearance analysis for the respective variable-sized partition from the clearance workers. At act 318, the consolidated clearance results set for the product assembly are output on a graphical user interface.

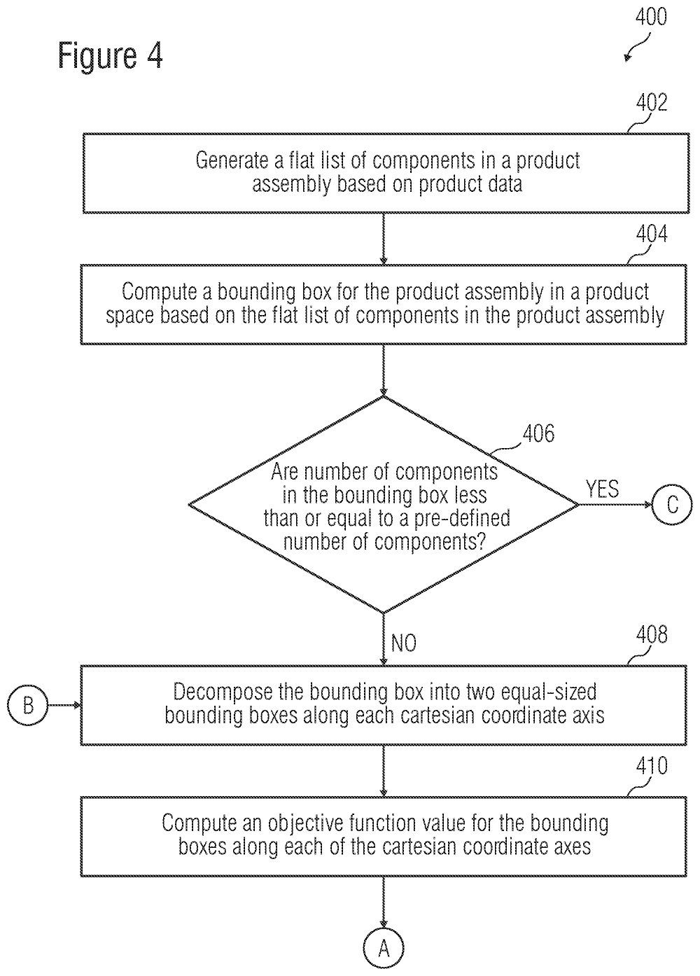

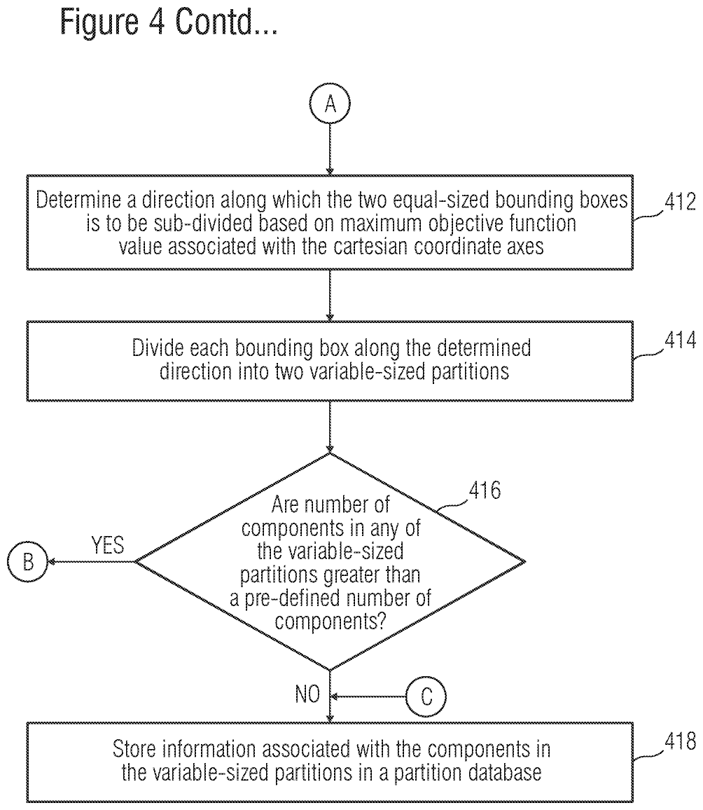

FIG. 4 is a process flowchart 400 of an exemplary method of iteratively decomposing a product space including a product assembly in a CAD environment into a plurality of variable-sized partitions, according to one embodiment. At act 402, a flat list of components in the product assembly is generated based on the product data. The flat list of the components includes information related to unique identifier of each component, location of each component in the product space, and bounding box associated with each component. At act 404, a bounding box for the product assembly in the product space is computed based on the flat list of components in the product assembly. At act 406, it is determined whether the number of components in the bounding box is less than or equal to a pre-defined number of components. For example, the pre-defined number of components are computed as a proportion of total number of components in the flat list of components in the product assembly. If the number of components in the bounding box is less than or equal to the pre-defined number of components, then act 418 is performed, where the information associated with the components in the bounding box is stored in a partition database 116.

If the number of components in the bounding box is greater than the pre-defined number of components, then in act 408, the bounding box is decomposed into two equal sized bounding boxes along a cartesian coordinate axes. At act 410, an objective function value for the bounding boxes is computed along each of the cartesian coordinate axes. The objective function value helps to minimize deviation between the number of components in the bounding boxes, and also minimize an increase of the number of components at each binary division. The objective function is computed using the following formulae:

$$F = \frac{N}{2} + \frac{k 1}{\vert n ( z 1 ) - n ( z 2 ) \vert + 1} * \frac{k 2}{\{ ( n ( z 1 ) + n ( z 2 ) - n ( Z ) \} + 1}$$

where:
N is a number of variable-sized partitions that contain components less than the pre-defined number of components along the current direction (N is 0, 1 or 2);
Z is a current bounding box being partitioned;
z1 and z2 are current sub-partitions along a direction being evaluated;
n(z) is a number of components in the current bounding box Z; and
k1 and k2 are parameters that change weightage of each factor.

Initially, k1 and k2 are set to a value 1. The value is adjusted based on results of quality of partitioning adjusted and type of product assemblies having a clearance analysis that is being performed.

At act 412, a direction along which the two equal sized bounding boxes is to be sub-divided is determined based on a maximum objective function value associated with each cartesian coordinate axes. At act 414, each bounding box is divided along the determined direction into two variable-sized partitions.

At act 416, it is determined whether number of components in any of the variable-sized partitions is greater than the pre-defined number of components. If the number of components in any of the variable-sized partitions is greater than the pre-defined number of components, the process is routed to act 408, and acts 408 to 416 are repeated until the number of components in each variable-sized partition is less than or equal to the pre-defined number of components. For example, generation of variable-sized partitions is halted when the number of components in the variable-sized partition is less than or equal to the pre-defined number of components (e.g., 200 number of components). The pre-defined number of components is computed based on a proportion of total number of components in the flat list of components in the product assembly. Additionally, a hardware configuration associated with the clearance workers 208A-N may be considered for determining the pre-defined number of components. If the number of components in any of the variable-sized partitions is less than or equal to the pre-defined number of components, then at act 418, information associated with the components in the variable-sized partitions is stored in the partition database 116. According to the above method, the clearance analysis cost for a variable-sized partition is assumed to be proportional to the number of components in the variable-sized partition.

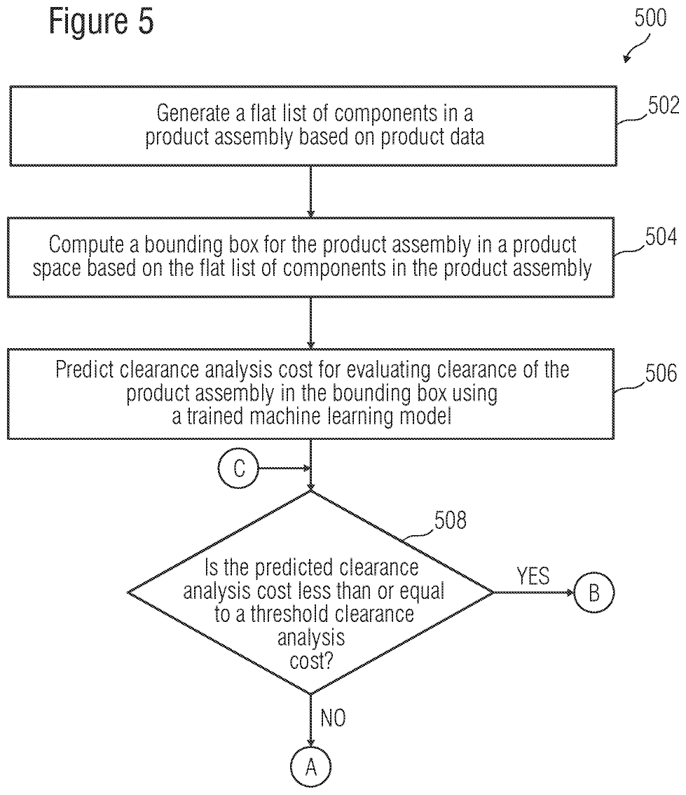

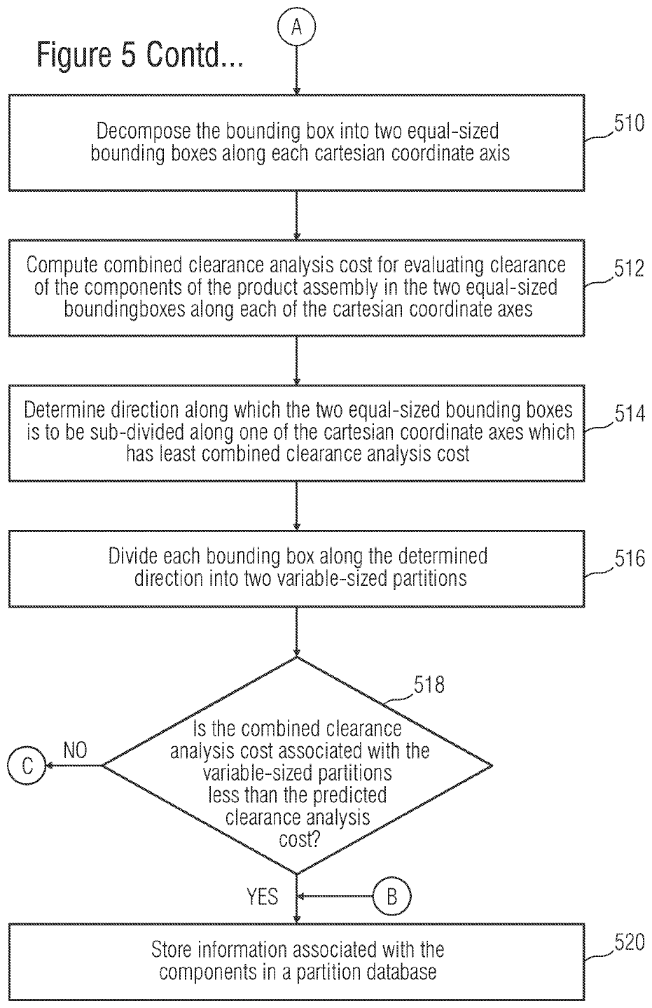

FIG. 5 is a process flowchart 500 of an exemplary method of iteratively decomposing a product space including a product assembly in a CAD environment into a plurality of variable-sized partitions, according to another embodiment. At act 502, a flat list of components in the product assembly is generated based on the product data. The flat list of the components includes information related to a unique identifier of each component, a location of each component in the product space, and a bounding box associated with each component. At act 504, a bounding box for the product assembly in the product space is computed based on the flat list of components in the product assembly. At act 506, the clearance analysis cost for evaluating clearance of the product assembly in the bounding box is predicted using a trained machine learning model. The predicted clearance analysis cost is a function of geometric complexity and location of components in the product assembly. In an embodiment, a feature vector is generated from properties associated with each component pair in the product assembly. The feature vector includes a size of the bounding box, a count of geometric entities in each component, geometric properties of a pair of components (e.g., area, perimeter, and type of geometries (analytic faces, non-analytic faces, etc.)). The feature vector is inputted to the trained machine learning model (e.g., a random forest model). The machine-learning model is trained using a feature vector of different component pairs. The clearance analysis cost computed by the machine learning model is compared with expected clearance analysis cost. Weights associated with nodes of the machine learning mode are computed and adjusted based on an error between the computed clearance analysis cost and the expected clearance analysis cost.

At act 508, it is determined whether the predicted clearance analysis cost is less than or equal to a threshold clearance analysis cost. If it is determined that the predicted clearance analysis cost is less than or equal to the threshold clearance analysis cost, then at act 520, the information associated with the components in the bounding box is stored in the partition database 116. If it is determined that the predicted clearance analysis cost is greater than the threshold clearance analysis cost, then at act 510, the bounding box is decomposed into two equal-sized bounding boxes along the cartesian coordinate axes. At act 512, a combined clearance analysis cost is computed for evaluating clearance of the components of the product assembly in the two equal-sized bounding boxes along each of the cartesian coordinate axes.

At act 514, a direction along which the two equal-sized bounding boxes is to be sub-divided along one of the cartesian coordinate axes, which has a least combined clearance analysis cost is determined. At act 516, each bounding box is divided along the determined direction into two variable-sized partitions. At act 518, it is determined whether the least combined clearance analysis cost associated with the variable-sized partitions is less than the predicted clearance analysis cost of the bounding box. If it is determined that the least combined clearance analysis cost associated with the variable-sized partitions is not less than the predicted clearance analysis cost of the bounding box, the process is routed to act 508, and acts 508 to 518 are repeated until the least combined clearance analysis cost for the variable-sized partitions becomes less than the predicted clearance analysis cost. If it is determined that the least combined clearance analysis cost associated with the variable-sized partitions is less than the predicted clearance analysis cost, then at act 520, the information associated with the components in the variable-sized partitions is stored in the partition database 116.

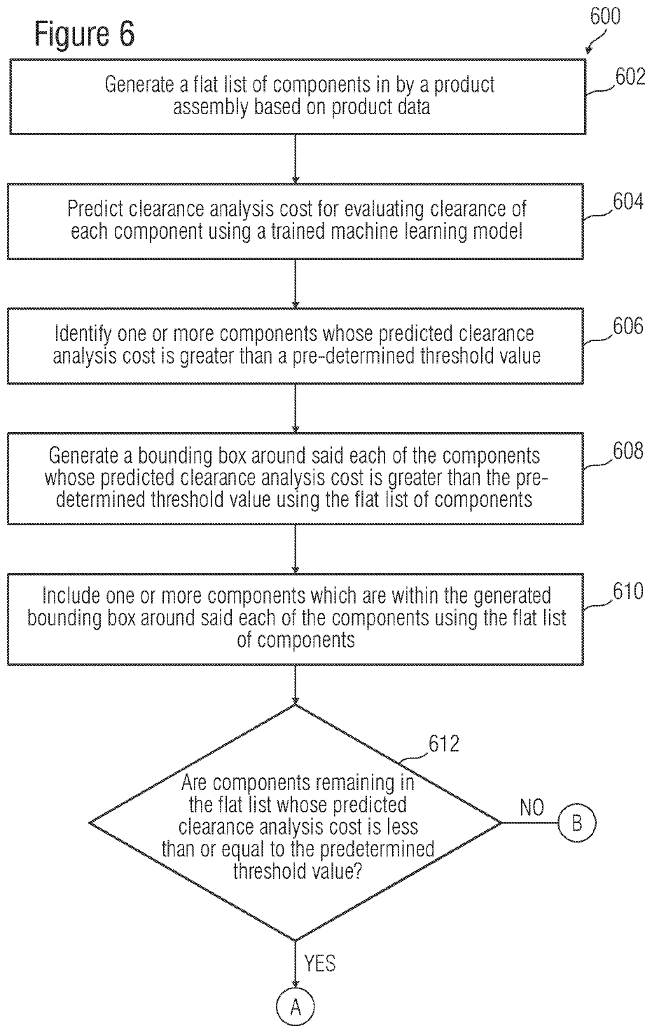

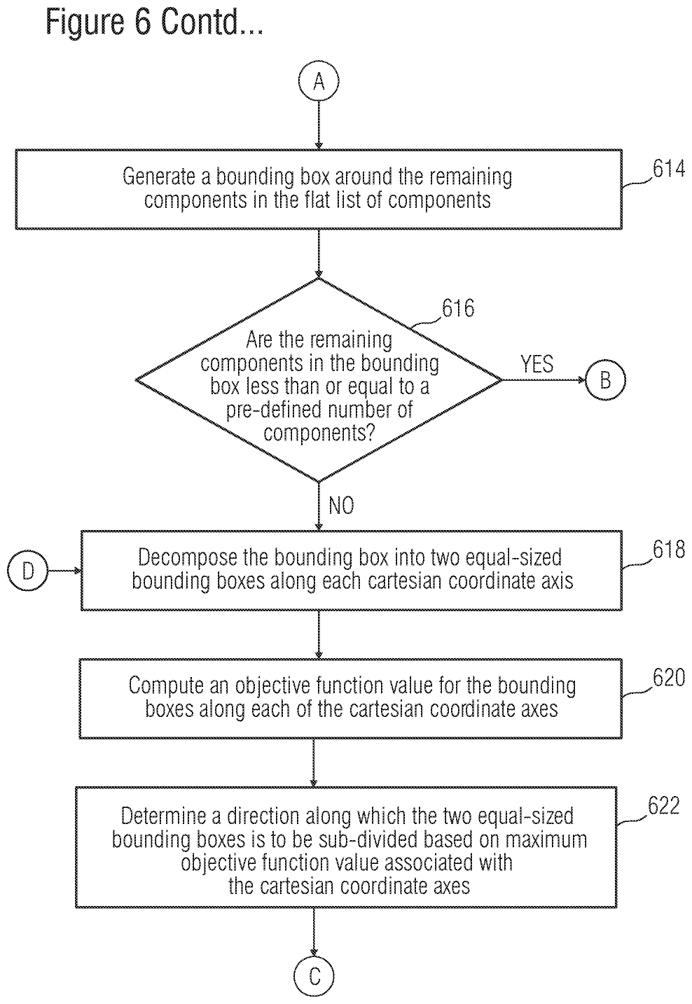

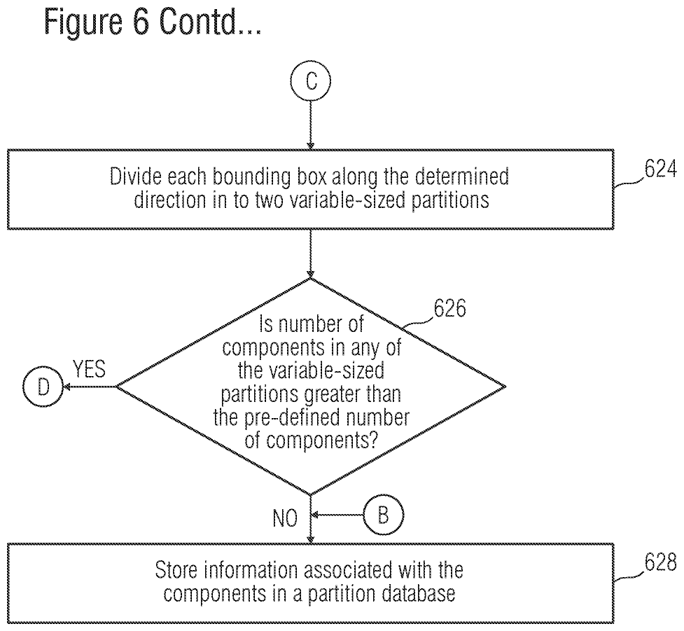

FIG. 6 is a process flowchart 600 of an exemplary method of iteratively decomposing a product space including a product assembly in a CAD environment into a plurality of variable-sized partitions, according to another embodiment. At act 602, a flat list of components in the product assembly is generated based on the product data. The flat list of the components includes information related to a unique identifier of each component, a location of each component in the product space, and a bounding box associated with each component.

At act 604, a clearance analysis cost for evaluating clearance of each component is predicted using the trained machine learning model (e.g., trained random forest model). The clearance analysis cost is a function of geometric complexity and location of components in the product assembly. At act 606, one or more components having a predicted clearance analysis cost that is greater than a pre-determined threshold value are identified.

At act 608, a bounding box is generated around the respective of the components having a predicted clearance analysis cost that is greater than the pre-determined threshold value using the flat list of components. At act 610, one or more components that are within the bounding box associated with the respective component is included from the flat list of components. At act 612, it is determined whether there are one or more components remaining in the flat list of components having a predicted analysis cost that is less than or equal to the predetermined threshold value. If no component having a predicted clearance analysis cost that is less than or equal to the pre-determined threshold value is remaining in the flat list, then at act 628, information associated with the components in the bounding boxes is stored in the partition database 116.

If it is determined that there are components remaining in the flat list that have a predicted clearance analysis cost that is less than or equal to the pre-determined threshold value, then at act 614, a bounding box is generated around the remaining components in the flat list of components. At act 616, it is determined whether the remaining components in the bounding box is less than or equal to a pre-defined number of components. If the remaining components in the bounding box is less than or equal to the pre-defined number of components, then act 628 is performed, where the information associated with the components in the bounding box is stored in a partition database 116.

If the remaining components in the bounding box is greater than the pre-defined number of components, then in act 618, the bounding box is decomposed into two equal sized bounding boxes along cartesian coordinate axes (e.g., X, Y, and Z). At act 620, an objective function value for the bounding boxes is computed along each of the cartesian coordinate axes. At act 622, a direction along which the two equal sized bounding boxes is to be sub-divided is determined based on a maximum objective function value associated with the cartesian coordinate axes. At act 624, each bounding box is divided along the determined direction into two variable-sized partitions.

At act 626, it is determined whether a number of components in any of the variable-sized partitions is greater than the pre-defined number of components. If the number of components in any of the variable-sized partitions is greater than the pre-defined number of components, the process is routed to act 618, and acts 618 to 626 are repeated until the number of components in each variable-sized partition is less than or equal to the pre-defined number of components. If the number of components in any of the variable-sized partitions is less than or equal to the pre-defined number of components, then at act 628, information associated with the components in the variable-sized partitions is stored in the partition database 116.

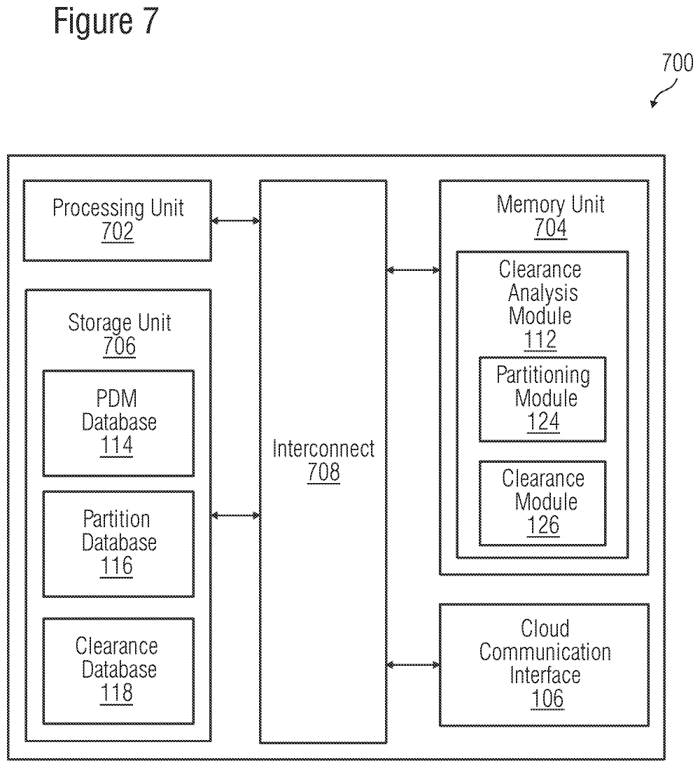

FIG. 7 is a schematic representation depicting the cloud computing system 102 as shown in FIG. 1, according to one embodiment. The data processing system 700 may be a personal computer, workstation, laptop computer, tablet computer, and the like. In FIG. 7, the cloud computing system 102 includes a processing unit 702, a memory unit 704, a storage unit 706, a bus 708, and the cloud communication interface 106. The processing unit 702, the memory unit 704, the storage unit 706, and/or the interconnect 708 may be part of the cloud computing infrastructure and OS 108 of FIG. 1.

The processing unit 702, as used herein, may be any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processing unit 702 may also include embedded controllers, such as generic or programmable logic devices or arrays, application specific integrated circuits, single-chip computers, and the like.

The memory unit 704 may be non-transitory volatile memory and non-volatile memory. The memory unit 704 may be coupled for communication with the processing unit 702, such as being a computer-readable storage medium. The processing unit 702 may execute instructions and/or code stored in the memory unit 704. A variety of computer-readable instructions may be stored in and accessed from the memory unit 704. The memory unit 704 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

In the present embodiment, the memory unit 704 includes a clearance analysis module 112 stored in the form of machine-readable instructions on any of the above-mentioned storage media and may be in communication with and executed by the processing unit 702. When the machine-readable instructions are executed by the processing unit 702, the clearance analysis module 112 causes the processing unit 702 to generate variable-sized partitions by decomposing product space including a product assembly, and perform clearance analysis on the components in the variable-sized partitions using the clearance workers 208A-N.

The storage unit 706 may be a non-transitory storage medium that stores the PDM database 114, the partition database 116, and the clearance database 118. The interconnect 708 acts as interface between the processing unit 702, the memory unit 704, and the storage unit 706. The cloud communication interface 106 enables communication between the cloud computing system 102 and user devices 120A-N such as a smart phone, a tablet computer, a desktop computer, etc. via the network 104.

Those of ordinary skilled in the art will appreciate that the hardware components depicted in FIG. 7 may vary for particular implementations. For example, other peripheral devices such as an optical disk drive and the like, a Local Area Network (LAN)/Wide Area Network (WAN)/Wireless (e.g., Wi-Fi) adapter, a graphics adapter, a disk controller, and/or an input/output (I/O) adapter may also be used in addition to or in place of the hardware depicted. The depicted example is provided for the purpose of explanation only and is not meant to imply architectural limitations with respect to the present disclosure.

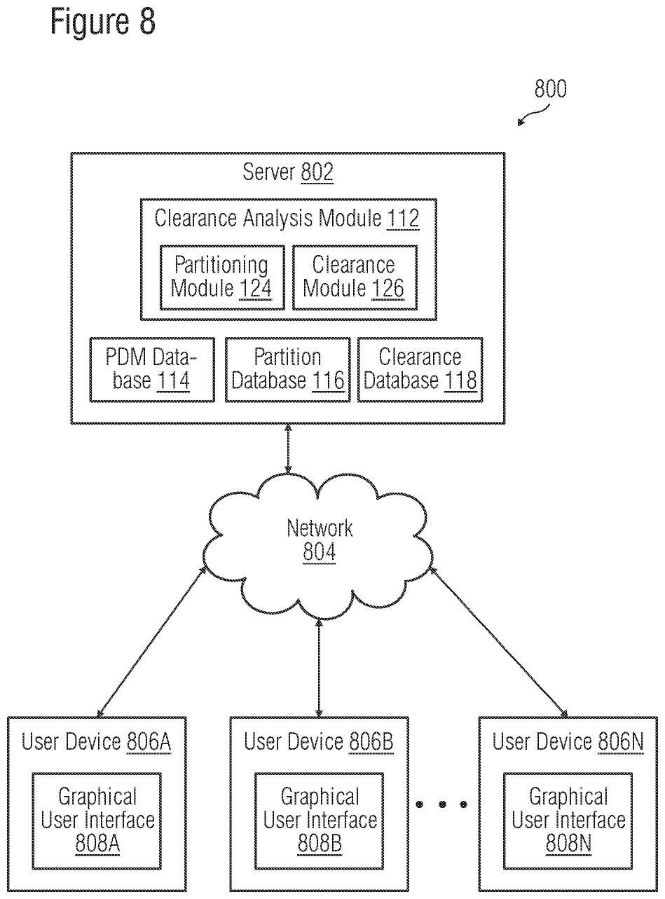

FIG. 8 illustrates a block diagram of a data processing system 800 for performing clearance analysis on a product assembly in a computer-aided design (CAD) environment, according to another embodiment. For example, the data processing system 800 includes a server 802 and a plurality of user devices 806A-N. Each of the user devices 806A-N is connected to the server 802 via a network 804 (e.g., Local Area Network (LAN), Wide Area Network (WAN), Wi-Fi, etc.). The data processing system 800 is another implementation of the data processing system 100 of FIG. 1, where the clearance analysis module 112 resides in the server 802 and is accessed by user devices 806A-N via the network 804.

The server 802 includes the clearance analysis module 112, the PDM database 114, the partition database 116, and the clearance database 116. The server 802 may also include a processing unit, a memory unit, and a storage unit. The clearance analysis module 112 may be stored on the memory unit in the form of machine-readable instructions and executable by the processing unit. The PDM database 114, the partition database 116, and the clearance database 116 may be stored in the storage unit. The server 802 may also include a communication interface for enabling communication with the user devices 806A-N via the network 804.

When the machine-readable instructions are executed by the processing unit, the clearance analysis module 112 causes the server 802 to iteratively decompose a product space including the product assembly into variable-sized partitions having a variable number of components in the product assembly, distribute the variable-sized partitions among the clearance workers 208A-N, evaluate clearance between the components in the respective variable-sized partitions using one or more clearance workers 208A-N, and output a clearance result set for the product assembly based on the evaluation of clearance between the components. Method acts performed by the server 802 to achieve the above-mentioned functionality are described in greater detail in FIGS. 3 to 6.

The user devices 812A-N include graphical user interfaces 814A-N for receiving a request for performing clearance analysis of the product assembly and displaying the clearance result set for the product assembly. Each of the user devices 812A-N may be provided with a communication interface for interfacing with the server 802. Users of the user devices 812A-N may access the server 802 via the graphical user interfaces 814A-N. For example, the users may send a request to the server 802 to perform clearance analysis of the product assembly. The graphical user interfaces 814A-N may be specifically configured for accessing the clearance analysis module 112 in the server 802.

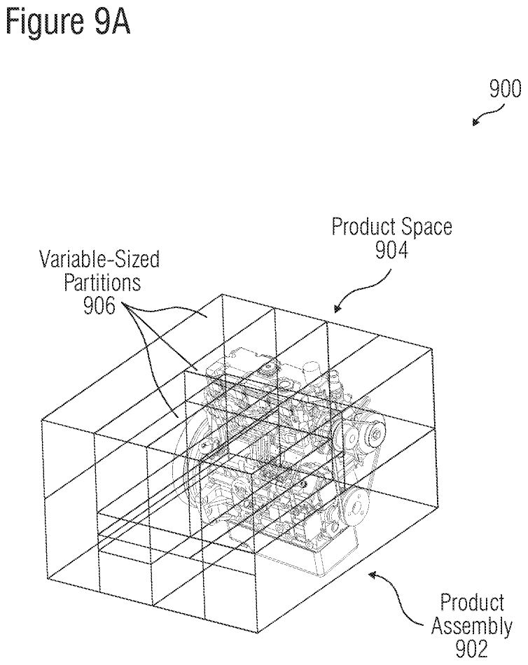

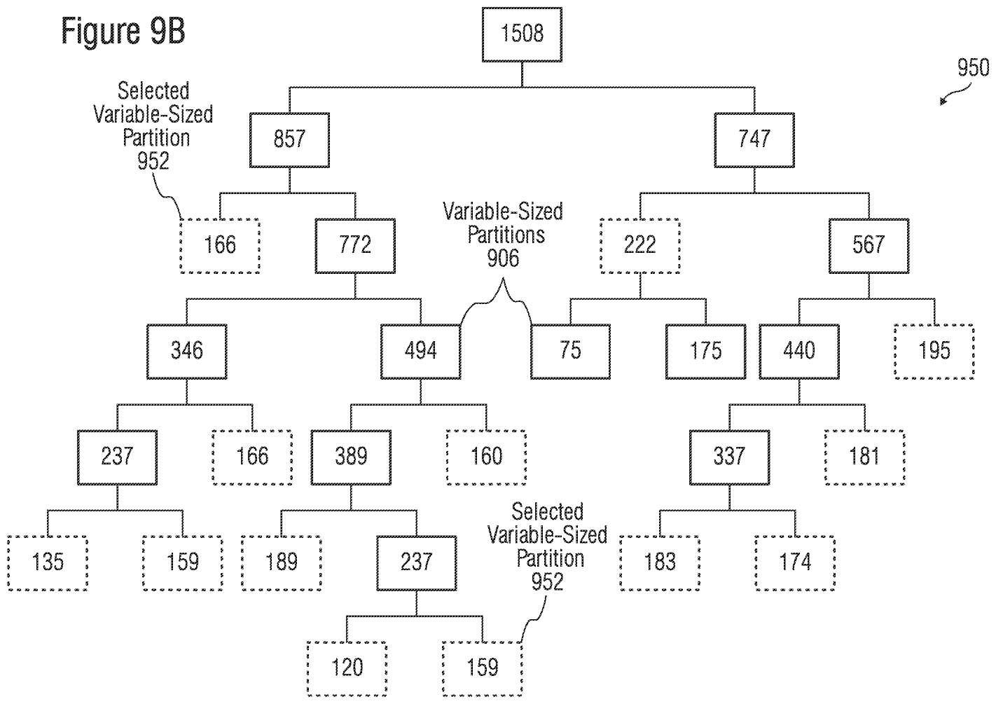

FIG. 9A is a schematic representation 900 depicting a product space 904 including a product assembly 902 partitioned into a plurality of variable-sized partitions 906 using a partitioning strategy, according to one embodiment. As shown in FIG. 9A, the product space 904 includes the product assembly 902 of an automobile engine. The product assembly 902 includes a plurality of components for which a clearance analysis needs to be performed. The product space 904 is iteratively decomposed into the plurality of variable-sized partitions 906 using a partitioning strategy (e.g., optimal number of components in each partition, optimal clearance analysis cost for each partition), as is illustrated in FIG. 9A.

FIG. 9B is a schematic representation 950 depicting partitioning of the product space into variable-sized partitions and a number of components in each variable-sized partition, according to one embodiment. As shown, the product assembly 902 with 1508 components is decomposed into 26 variable-sized partitions 906. Each block shown in FIG. 9B indicates a number of components in the respective variable-sized partition 906. The dotted boxes indicate the variable-sized partitions 952 selected from the variable-sized partitions 906 based on an optimal number of components in a partition and/or an optimal clearance analysis cost for each partition. The selected variable-sized partitions 952 are distributed among the clearance workers 208A-N so that each of the clearance workers 208A-N perform clearance analysis for the respective variable-sized partition(s) 952.

In accordance with the foregoing embodiments, the data processing systems 100 and 800 performs clearance analysis by partitioning product assembly into variable-sized partitions using partitioning strategies (as shown in FIGS. 4 to 6) and evaluating clearance between components in each variable-sized partition using respective clearance workers such that each clearance worker takes substantially equal time for generating results of clearance analysis. The partitioning strategies help decompose product space into variable-sized partitions such that each clearance worker takes approximately a same amount of compute time, resulting in faster clearance analysis. The clearance workers substantially reduce the time for clearance analysis and provide that the cost of clearance analysis do not scale up with size of product assembly. Further, the data processing systems 100 and 800 are capable to persist the variable-sized partitions in the partition database for the product assembly such that any changes to the underlying product data would not lead to re-creation of partitions across multiple subsequent clearance runs for the same product assembly. The variable partitions containing updated components are updated prior to performing clearing analysis for the product assembly. Also, the data processing systems 100 and 800 are capable of rebuilding partition data into new substructures, thereby eliminating cost of configuring and loading original product assembly for each partition during clearance analysis.

The system and methods described herein may be implemented in various forms of hardware, software, firmware, special purpose processing units, or any combination thereof. One or more of the present embodiments may take a form of a computer program product including program modules accessible from computer-usable or computer-readable medium storing program code for use by or in connection with one or more computers, processing units, or instruction execution system. For the purpose of this description, a computer-usable or computer-readable medium may be any apparatus that may contain, store, communicate, propagate, or transport the program for use by or in connection with the instruction execution system, apparatus, or device. The medium may be an electronic, magnetic, optical, electromagnetic, infrared, or semiconductor system (or apparatus or device), or propagation mediums in and of themselves, as signal carriers are not included in the definition of physical computer-readable medium including a semiconductor or solid state memory, magnetic tape, a removable computer diskette, random access memory (RAM), a read only memory (ROM), a rigid magnetic disk, an optical disk such as compact disk read-only memory (CD-ROM), a compact disk read/write, a digital versatile disc (DVD), or any combination thereof. Both processing units and program code for implementing each aspect of the technology may be centralized or distributed (or a combination thereof) as known to those skilled in the art.

While the present disclosure has been described in detail with reference to certain embodiments, the present disclosure is not limited to those embodiments. In view of the present disclosure, many modifications and variations would present themselves to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within the scope.

The elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method of performing clearance analysis of a product assembly in a computer-aided design (CAD) environment, comprising:
receiving, by a data processing system, a request for evaluating clearance between components of a product assembly in a CAD environment from a graphical user interface of a user device, wherein the request comprises an unique identifier of each component of the product assembly;
obtaining, by the data processing system, product data associated with the components of the product assembly from a product data management (PDM) database based on the unique identifier of the product assembly;
iteratively decomposing, by the data processing system, a product space comprising the product assembly in the CAD environment into a plurality of variable-sized partitions based on the product data and a partitioning strategy;
selecting, by the data processing system, one or more variable-sized partitions for evaluating clearance between the components in the product assembly from the plurality of the variable-sized partitions; and
evaluating, by a plurality of clearance workers in the data processing system, clearance between the components in the selected variable-sized partitions, wherein, based on the partitioning strategy, each clearance worker of the plurality of clearance workers takes a substantially same amount of compute time to evaluate the clearance, such that an overall time, cost, or time and cost for performing the clearance analysis is reduced.

2. The method of claim 1, wherein iteratively decomposing the product space comprising the product assembly in the CAD environment into the plurality of variable-sized partitions, comprises:
generating a flat list of the components in the product assembly based on the product data, wherein the flat list of the components comprises information related to unique identifier of each component, location of each component in the product space, and bounding box associated with each component;
computing a bounding box for the product assembly in the product space based on the flat list of components in the product assembly; and
iteratively decomposing the bounding box comprising the product assembly in the product space into the plurality of variable-sized partitions.

3. The method of claim 2, wherein iteratively decomposing the bounding box comprising the product assembly in the product space into the plurality of variable-sized partitions comprises:
decomposing the bounding box into at least two equal sized bounding boxes along each cartesian coordinate axis;
determining a direction along which the two equal sized bounding boxes is to be sub-divided based on maximum objective function value associated with the cartesian coordinate axes;
dividing the two equal-sized bounding boxes along the determined direction into a number of variable-sized partitions;
determining whether the number of components in any of the variable-sized partitions is greater than the pre-defined number of components;
if the number of components in any of the variable-sized partitions is greater than the pre-defined number of components, repeating the steps of decomposing, determining, dividing, and determining till the number of components in each variable-sized partition is less than or equal to the pre-defined number of components; and
if the number of components in any of the variable-sized partitions is not greater than the pre-defined number of components, storing information associated with the variable-sized partitions in a partition database.

4. The method of claim 2, wherein iteratively decomposing the bounding box comprising the product assembly in the product space into the plurality of variable-sized partitions comprises:
predicting clearance analysis cost for evaluating clearance of the product assembly in the bounding box;
determining whether the predicted clearance analysis cost is less than or equal to a threshold clearance analysis cost;
if the predicted clearance analysis cost is less than or equal to the threshold clearance analysis cost, decomposing the bounding box into at least two equal-sized bounding boxes along cartesian coordinate axes;
computing combined clearance analysis cost for evaluating clearance of the components of the product assembly in the two equal-sized bounding boxes along each of the cartesian coordinate axes;
determining a direction along which the two equal-sized bounding boxes is to be sub-divided along one of the cartesian coordinate axes which has least combined clearance analysis cost;
dividing each bounding box along the determined direction into two variable-sized partitions;
determining whether the least combined clearance analysis cost associated with the variable-sized partitions is less than the predicted clearance analysis cost;
if the least combined clearance analysis cost associated with the variable-sized partitions is not less than the predicted clearance analysis cost, repeating the steps of determining, decomposing, computing, determining, dividing, and determining till the least combined clearance analysis cost for the variable-sized partitions becomes less than the predicted clearance analysis cost; and
if the at least combined clearance analysis cost associated with the variable-sized partitions is less than the predicted clearance analysis cost, storing information associated with the variable-sized partitions in a partition database.

5. The method of claim 4, wherein predicting the clearance analysis cost for evaluating clearance of the product assembly in the bounding box comprises:
predicting the clearance analysis cost for evaluating clearance of the product assembly in the bounding box using a trained machine learning model.

6. The method of claim 1, wherein iteratively decomposing the product space comprising the product assembly in the CAD environment into the plurality of variable-sized partitions, comprises:
generating a flat list of the components in the product assembly based on the product data, wherein the flat list of the components comprises information related to unique identifier of each component, location of each component in the product space, and bounding box associated with each component;
predicting clearance analysis cost for evaluating clearance of each component in the product assembly;
identifying one or more components whose predicted clearance analysis cost is greater than a predetermined threshold value;
computing a bounding box around each of the components whose predicted clearance analysis cost is greater than the predetermined threshold value based on the flat list of components, wherein the bounding box associated with each component comprises one or more components which are within the bounding box of said each component;
determining whether there are one or more components remaining in the flat list whose predicted clearance analysis cost is less than or equal to the pre-determined threshold value; and
if there are no components remaining in the flat list, storing information associated with the bounding boxes in a partition database.

7. The method of claim 6, wherein determining whether there are one or more components remaining in the flat list whose predicted clearance analysis cost is less than or equal to the pre-determined threshold value comprises:
if there are one or more components remaining in the flat list, generating a bounding box for the remaining components in the flat list of components;
decomposing the bounding box into at least two equal sized bounding boxes along each cartesian coordinate axis;
determining a direction along which the two equal sized bounding boxes is to be sub-divided based on maximum objective function value associated with the cartesian coordinate axes;
dividing the two equal-sized bounding boxes along the determined direction into a number of variable-sized partitions;
determining whether the number of components in any of the variable-sized partitions is greater than the pre-defined number of components;
if the number of components in any of the variable-sized partitions is greater than the pre-defined number of components, repeating the steps of decomposing, determining, dividing, and determining till the number of components in each variable-sized partition is less than or equal to the pre-defined number of components; and
if the number of components in any of the variable-sized partitions is not greater than the pre-defined number of components, storing information associated with the variable-sized partitions in the partition database.

8. The method of claim 1, wherein selecting the one or more variable-sized partitions for evaluating clearance between the components in the product assembly comprises:
selecting the one or more variable-sized partitions from the plurality of variable-sized partitions based on at least one of pre-defined number of components in the variable-sized partitions and threshold clearance analysis cost associated with the variable-sized partitions.

9. The method of claim 1, wherein evaluating the clearance between the components in the respective variable-sized partitions comprises:
distributing the selected variable-sized partitions among a plurality of clearance workers in the data processing system, wherein each of the selected variable-sized partitions comprises one or more component pairs on which clearance analysis needs to be performed;
performing a clearance analysis on said each component pair in the respective variable-sized partitions using the clearance workers; and
generating results of the clearance analysis performed on said each component pair in the respective variable-sized partitions.

10. The method of claim 9, further comprising:
generating a consolidated clearance result set for the product assembly based on the results of the clearance analysis for the respective variable-sized partition from the clearance workers; and
outputting the consolidated clearance results set for the product assembly on a graphical user interface.

11. A data processing system for performing clearance analysis of a product assembly in a computer-aided design (CAD) environment, comprising:
a processing unit; and
a memory unit communicatively coupled to the processing unit, wherein the memory unit comprises a clearance analysis module configured to:
receive a request for evaluating clearance between components of a product assembly in a CAD environment from a user device, wherein the request comprises an unique identifier of each component of the product assembly;
obtain product data associated with the components of the product assembly from a product data management (PDM) database based on the unique identifier of the components of the product assembly;
iteratively decompose a product space comprising the product assembly in the CAD environment into a plurality of variable-sized partitions based on the product data and a partitioning strategy;
select one or more variable-sized partitions for evaluating clearance between the components in the product assembly from the plurality of the variable-sized partitions; and
evaluate, by a plurality of clearance workers, clearance between the components in the selected variable-sized partitions, wherein, based on the partitioning strategy, each clearance worker of the plurality of clearance workers takes a substantially same amount of compute time to evaluate the clearance, such that an overall time, cost, or time and cost for performing the clearance analysis is reduced.

12. The data processing system of claim 11, wherein in iteratively decomposing the product space comprising the product assembly in the CAD environment into the plurality of variable-sized partitions, the clearance analysis module is configured to:
generate a flat list of the components in the product assembly based on the product data, wherein the flat list of the components comprises information related to unique identifier of each component, location of each component in the product space, and bounding box associated with each component;
compute a bounding box for the product assembly in the product space based on the flat list of components in the product assembly; and
iteratively decompose the bounding box comprising the product assembly in the product space into the plurality of variable-sized partitions.

13. The data processing system of claim 12, wherein in iteratively decomposing the bounding box comprising the product assembly in the product space into the plurality of variable-sized partitions, the clearance analysis module is configured to:
decompose the bounding box into two equal sized bounding boxes along each cartesian coordinate axis;
determine a direction along which the two equal sized bounding boxes is to be sub-divided based on maximum objective function value associated with the cartesian coordinate axes;
divide the two equal-sized bounding boxes along the determined direction into a number of variable-sized partitions;
determine whether the number of components in any of the variable-sized partitions is greater than the pre-defined number of components;
if the number of components in any of the variable-sized partitions is greater than the pre-defined number of components, repeat the steps of decomposing, determining, dividing, and determining till the number of components in each variable-sized partition is less than or equal to the pre-defined number of components; and
if the number of components in any of the variable-sized partitions is not greater than the pre-defined number of components, store information associated with the variable-sized partitions in a partition database.

14. The data processing system of claim 12, wherein in iteratively decomposing the bounding box comprising the product assembly in the product space into the plurality of variable-sized partitions, the clearance analysis module is configured to:
predict clearance analysis cost for evaluating clearance of the product assembly in the bounding box;
determine whether the predicted clearance analysis cost is less than or equal to a threshold clearance analysis cost;
if the predicted clearance analysis cost is less than or equal to the threshold clearance analysis cost, decompose the bounding box into at least two equal-sized bounding boxes along cartesian coordinate axes;
compute combined clearance analysis cost for evaluating clearance of the components of the product assembly in the two equal-sized bounding boxes along each of the cartesian coordinate axes;
determine a direction along which the two equal-sized bounding boxes is to be sub-divided along one of the cartesian coordinate axes which has least combined clearance analysis cost;
divide each bounding box along the determined direction into two variable-sized partitions;
determine whether the at least combined clearance analysis cost associated with the variable-sized partitions is less than the predicted clearance analysis cost;
if the least combined clearance analysis cost associated with the variable-sized partitions is not less than the predicted clearance analysis cost, repeat the steps of determining, decomposing, computing, determining, dividing, and determining till the at least combined clearance analysis cost for the variable-sized partitions becomes less than the predicted clearance analysis cost; and
if the least combined clearance analysis cost associated with the variable-sized partitions is less than the predicted clearance analysis cost, store information associated with the variable-sized partitions in a partition database.

15. The data processing system of claim 14, wherein in predicting the clearance analysis cost for evaluating clearance of the product assembly in the bounding box, the clearance analysis module is configured to predict the clearance analysis cost for evaluating clearance of the product assembly in the bounding box using a trained machine learning model.

16. The data processing system of claim 11, wherein in iteratively decomposing the product space comprising the product assembly in the CAD environment into the plurality of variable-sized partitions, the clearance analysis module is configured to:
generate a flat list of the components in the product assembly based on the product data, wherein the flat list of the components comprises information related to unique identifier of each component, location of each component in the product space, and bounding box associated with each component;
predict clearance analysis cost for evaluating clearance of each component in the product assembly;
identify one or more components whose predicted clearance analysis cost is greater than a predetermined threshold value;
compute a bounding box around each of the components whose predicted clearance analysis cost is greater than the predetermined threshold value based on the flat list of components, wherein the bounding box associated with each component comprises one or more components which are within the bounding box of said each component;
determine whether there are one or more components remaining in the flat list whose predicted clearance analysis cost is less than or equal to the pre-determined threshold value; and
if there are no components remaining in the flat list, store information associated with the bounding boxes in a partition database.

17. The data processing system of claim 16, wherein in determining whether there are one or more components remaining in the flat list whose predicted clearance analysis cost is less than or equal to the pre-determined threshold value, the clearance analysis module is configured to:
if there are one or more components remaining in the flat list, generate a bounding box for the remaining components in the flat list of components;
decompose the bounding box into at least two equal sized bounding boxes along each cartesian coordinate axis;
determine a direction along which the two equal sized bounding boxes is to be sub-divided based on maximum objective function value associated with the cartesian coordinate axes;
divide the two equal-sized bounding boxes along the determined direction into a number of variable-sized partitions;
determine whether the number of components in any of the variable-sized partitions is greater than the pre-defined number of components;
if the number of components in any of the variable-sized partitions is greater than the pre-defined number of components, repeat the steps of decomposing, determining, dividing, and determining till the number of components in each variable-sized partition is less than or equal to the pre-defined number of components; and
if the number of components in any of the variable-sized partitions is not greater than the pre-defined number of components, store information associated with the variable-sized partitions in the partition database.

18. The data processing system of claim 11, wherein in selecting the one or more variable-sized partitions for evaluating clearance between the components in the product assembly, the clearance analysis module is configured to:
select the one or more variable-sized partitions from the plurality of variable-sized partitions based on at least one of pre-defined number of components in the variable-sized partitions and threshold clearance analysis cost associated with the variable-sized partitions.

19. The data processing system of claim 11, wherein in evaluating the clearance between the components in the respective variable-sized partitions, the clearance analysis module is configured to:
distribute the selected variable-sized partitions among a plurality of clearance workers in the data processing system, wherein each of the selected variable-sized partitions comprises one or more component pairs on which clearance analysis needs to be performed;
perform a clearance analysis on said each component pair in the respective variable-sized partitions using the clearance workers; and
generate results of the clearance analysis performed on said each component pair in the respective variable-sized partitions.

20. The data processing system of claim 19, wherein the clearance analysis module is configured to:
generate a consolidated clearance result set for the product assembly based on the results of the clearance analysis for the respective variable-sized partition from the clearance workers; and
output the consolidated clearance results set for the product assembly on a graphical user interface.
